(19) United States
(12) Patent Application Publication
(10) Pub. No.: US 2026/0042144 A1
(43) Pub. Date: Feb. 12, 2026

(54) ADDITIVE MANUFACTURING TECHNIQUES FOR SELECTIVE DENSITY GRADIENT LOCATION

(71) Applicant: KENNAMETAL INC., Latrobe, PA (US)

(72) Inventors: Paul D. Prichard, Latrobe, PA (US); Matthew Bonidie, Latrobe, PA (US); Zhuqing Wang, Latrobe, PA (US)

(21) Appl. No.: 18/798,468

(22) Filed: Aug. 8, 2024

(51) Int. Cl. B22F 7/06; B22F 3/11; B22F 10/66; B33Y 10/00; B33Y 40/20; B33Y 80/00

(52) U.S. Cl. CPC B22F 7/062; B22F 10/66; B33Y 10/00; B33Y 40/20; B22F 2003/1106; B22F 2007/066; B22F 2302/10; B22F 2998/10; B33Y 80/00

(57) ABSTRACT

In one aspect, additive manufacture techniques are described herein which enable the selective location of one or more density gradients within printed articles. Methods described herein can permit high density and high quality printed regions to be located at one or more selected areas of the printed article. The high density/high quality printed regions, for example, can be located at functional areas of the printed article, such as areas of high wear and/or stress.

### FIELD

The present invention relates to additive manufacturing techniques and, in particular, to additive manufacturing techniques operable to selectively locate one or more density gradients within printed articles. 16

### BACKGROUND

Additive manufacturing generally encompasses processes in which digital 3-dimensional (3D) design data is employed to fabricate an article or component in layers by material deposition and processing. Various techniques have been developed falling under the umbrella of additive manufacturing. Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process and precluding the requirement of mold lubricants and coolant. Most importantly, additive manufacturing enables significant freedom in article design. Articles having highly complex shapes can be produced without significant expense allowing the development and evaluation of a series of article designs prior to final design selection.

### SUMMARY

In one aspect, additive manufacture techniques are described herein which enable the selective location of one or more density gradients within printed articles. Methods described herein can permit high density and high quality printed regions to be located at one or more selected areas of the printed article. The high density/high quality printed regions, for example, can be located at functional areas of the printed article, such as areas of high wear and/or stress. Moreover, the remainder of the printed article is not subject to stringent tolerances and/or performance metrics. In this way, production economies can be realized without sacrificing article performance and/or quality.

In some embodiments, a method of making a sintered article comprises printing a body from a powder composition via one or more additive manufacturing techniques, and selectively locating at least one region of unprinted loose powder in the body during the printing, the at least one region defined by a boundary printed from the powder composition. The printed body, printed boundary, and the unprinted loose powder region are sintered to provide the sintered article, wherein the sintered unprinted loose powder region has a density higher than sintered printed boundary and sintered printed body. In some embodiments, a plurality of regions are selectively located in the body. As described further herein, the regions of sintered unprinted loose powder can be selectively located at functional areas of the sintered article. Functional areas, for example, can experience higher mechanical stresses, higher wear, and/or higher thermal cycling relative to an adjacent area of the sintered article.

These and other embodiments are further described in the following detailed description.

### BRIEF DESCRIPTION OF THE DRAWINGS

FIG. 1 illustrates the results of a finite element analysis (FEA) to determine stress state of a transverse rupture bar while being tested according to ASTM B406.

FIG. 2 is a modeled internal region of sintered unprinted loose powder in a transverse rupture bar according to some embodiments.

FIG. 3(a) illustrates a transverse rupture bar comprises a region of sintered unprinted loose powder fabricated according to a method described herein.

FIG. 3(b) illustrates a transverse rupture bar fabricated according to a prior sintering method wherein the region of sintered unprinted loose powder is absent.

FIG. 4 illustrates transverse rupture testing of bars according to ASTM B406.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

A method of making a sintered article comprises printing a body from a powder composition via one or more additive manufacturing techniques, and selectively locating at least one region of unprinted loose powder in the body during the printing, the at least one region defined by a boundary printed from the powder composition. The printed body, printed boundary, and the unprinted loose powder region are sintered to provide the sintered article, wherein the sintered unprinted loose powder region has a density higher than sintered printed boundary and sintered printed body. In some embodiments, a plurality of regions are selectively located in the body. As described further herein, the regions of sintered unprinted loose powder can be selectively located at functional areas of the sintered article. Functional areas, for example, can experience higher mechanical stresses, higher wear, and/or higher thermal cycling relative to an adjacent area of the sintered article.

Turning now to specific components, the powder composition can comprise any powder consistent with the technical objectives described herein. In some embodiments, the powder composition comprises sintered cemented carbide particles. The sintered cemented carbide particles can have an apparent density of at least 6 g/cm³, in some embodiments. As known to one of skill in the art, apparent density is the mass of a unit volume of powder or particles in the loose condition, usually expressed in g/cm³. In some embodiments, sintered cemented carbide particles have apparent density of at least 7 g/cm³. Apparent density of sintered cemented carbide particles of powder compositions described herein can also have values selected from Table I.

TABLE I
Apparent Density of Sintered Cemented Carbide Particles

| | |
|---|---|
| ≥6.5 | g/cm³ |
| ≥7.5 | g/cm³ |
| ≥8 | g/cm³ |
| ≥9 | g/cm³ |
| 6-11 | g/cm³ |
| 7-11 | g/cm³ |
| 8-11 | g/cm³ |

Apparent density of sintered cemented particles can be determined according to ASTM B212 Standard Test Method for Apparent Density of Free-Flowing Metal Powders using the Hall Flowmeter Funnel.

In addition to apparent density, sintered cemented carbide particles of powder compositions described herein can have tap density of at least 7 g/cm³. In some embodiments, sintered cemented carbide particles exhibit tap density having a value selected from Table II.

TABLE II
Tap Density of Sintered Cemented Carbide Particles

| | |
|---|---|
| ≥7.5 | g/cm³ |
| ≥8 | g/cm³ |
| ≥8.5 | g/cm³ |
| ≥9.5 | g/cm³ |
| 7-12 | g/cm³ |
| 8-12 | g/cm³ |
| 9-12 | g/cm³ |

Tap density of sintered cemented carbide particles can be determined according to ASTM B527 Standard Test Method for Tap Density of Metal Powders and Compounds. In some embodiments, the ratio of tap density to apparent density (Hausner ratio) of sintered cemented carbide particles is 1.05 to 1.25. Hausner ratio of sintered cemented carbide particles, in some embodiments is 1.1 to less than 1.25.

In addition to apparent density and tap density, sintered cemented carbide particles described herein can have an average individual particle density of at least 80 percent theoretical density. In some embodiments, average individual particle density of the sintered cemented carbide particles is at least 90 percent or at least 95 percent theoretical density. Sintered cemented carbide particles can exhibit an average individual particle density of 80 to 95 percent theoretical density, in some embodiments. In further embodiments, sintered cemented carbide particles can exhibit an average individual particle density of 90 to 98 percent theoretical density.

As described further herein, the foregoing apparent densities, tap densities and individual particle densities can be achieved through one or several sintering processes administered to the particles. The sintering processes, in some embodiments, do not employ sintering inhibitor(s) to mitigate particle sticking or adhesion. Sintered cemented carbide particle properties described herein can be achieved in the absence of sintering inhibitor(s). In some embodiments, sintered cemented carbide particles are prepared by sintering a grade powder composition at temperatures of 1100° C. to 1400° C. for 0.5 to 2 hours to provide a sintered compact. The sintered compact is subsequently milled to provide individual sintered cemented carbide particles. Depending on particle morphology and density, the sintered cemented carbide particles can be further heat treated for further densification. Further heat treatment can include plasma densification, such as plasma spheroidization using an RF plasma torch or DC plasma torch. Alternatively, the sintered cemented carbide particles can be re-sintered forming a second compact. The second compact is milled to provide the sintered cemented carbide particles. Further densification treatments can be administered any desired number of times to provide sintered cemented carbide particles desired apparent densities, tap densities and/or individual particle densities. Sintering times and temperatures can be selected according to several considerations including, but not limited to, binder content of the cemented carbide particles, desired sintered particle density and sintering stage. In some embodiments, early sintering stages are conducted at lower temperatures and/or shorter times to facilitate milling the sintered compact. For example, an initial or early stage sintering process may be administered at temperatures below binder liquefaction. Late stage or final sintering processes may achieve higher temperatures, such as temperatures at which liquid phase sintering takes place.

Sintered cemented carbide particles can generally have an average size of 1 μm to 100 μm. In some embodiments, sintered cemented carbide particles have an average size selected from Table III.

```
TABLE III
Average Sintered Cemented Carbide Particle Size (μm)
  5-90
  5-50
10-75
10-50
  5-40
20-40
0.5-2
1-5
  1-10
```

Sintered cemented carbide particles can exhibit a Gaussian particle size distribution, in some embodiments. In other embodiments, sintered cemented carbide particles can have a polydisperse, bimodal or multi-modal particle size distribution. A bimodal particle size distribution, for example, can have any ratio of coarse particles to fine particles. In some embodiments, the coarse: fine particle ratio of 70:30 or 80:20. Coarse particles can have an average size greater than 20 μm, while fine particles have an average size less than 20 μm or less than 10 μm, in some embodiments. In some embodiments, the sintered cemented carbide particles exhibit a bimodal particle size distribution described in U.S. patent application Ser. No. 16/402,530 which is incorporated herein by reference in its entirety. The sintered cemented carbide particles, for example, can comprise a first mode having a D50 particle size of 25 μm to 50 μm, and a second mode having a D50 of less than 10 ∪m. Additionally, coarse and fine particles can have the same shape or different shapes. Particle shape can be spherical, polygonal or irregular. In further embodiments, sintered cemented carbide particles can be monodisperse or substantially monodisperse. In being substantially monodisperse, the cemented carbide particles are within ±10 percent or ±5 of the average particle size. In some embodiments, sintered cemented carbide particles are spherical or substantially spherical in shape. Alternatively, sintered cemented carbide particles can be a mixture of irregularly shaped particles with spherical or substantially spherical particles.

Sintered cemented carbide particles comprise one or more metal carbides selected from the group consisting of Group IVB metal carbides, Group VB metal carbides and Group VIB metal carbides. In some embodiments, tungsten carbide is the sole metal carbide of the sintered particles. In other embodiments, one or more Group IVB, Group VB and/or Group VIB metal carbides are combined with tungsten carbide to provide the sintered particles. For example, chromium carbide, titanium carbide, vanadium carbide, tantalum carbide, niobium carbide, zirconium carbide and/or hafnium carbide and/or solid solutions thereof can be combined with tungsten carbide in sintered particle production. Tungsten carbide can generally be present in the sintered particles in an amount of at least about 80 or 85 weight percent. In some embodiments, Group IVB, VB and/or VIB metal carbides other than tungsten carbide are present in the sintered particles in an amount of 0.1 to 5 weight percent.

In some embodiments, the sintered cemented carbide particles do not comprise double metal carbides or lower metal carbides. Double and/or lower metal carbides include, but are not limited to, eta phase (Co₃W₃C or Co₆W₆C), W₂C and/or W₃C. Moreover, sintered articles formed from sintered cemented carbide particles, in some embodiments, also do not comprise non-stoichiometric metal carbides. Additionally, the sintered cemented carbide particles can exhibit uniform or substantially uniform microstructure.

Sintered cemented carbide particles comprise metallic binder. Metallic binder of sintered cemented carbide particles can be selected from the group consisting of cobalt, nickel and iron and alloys thereof. In some embodiments, metallic binder is present in the sintered cemented carbide particles in an amount of 0.1 to 35 weight percent. Metallic binder can also be present in the sintered cemented carbide particles in an amount selected from Table IV.

```
TABLE IV
Metallic Binder Content (wt. %)
0.1-20
0.1-10
0.5-15
  1-10
  3-20
  5-15
12-15
10-35
15-35
15-25
```

Metallic binder of the sintered cemented carbide particles can also comprise one or more additives, such as noble metal additives. In some embodiments, the metallic binder can comprise an additive selected from the group consisting of platinum, palladium, rhenium, rhodium and ruthenium and alloys thereof. In other embodiments, an additive to the metallic binder can comprise molybdenum, silicon or combinations thereof. Additive can be present in the metallic binder in any amount not inconsistent with the objectives of the present invention. For example, additive(s) can be present in the metallic binder in an amount of 0.1 to 10 weight percent of the sintered cemented carbide particles.

Alternatively, the powder composition formed into the green article can comprise powder cobalt-based alloy. In some embodiments, the powder cobalt-based alloy has a composition selected from Table V.

TABLE V
Composition of Co-based Powder Alloy

| Element | Amount (wt. %) |
|---|---|
| Chromium | 15-35 |
| Tungsten | 0-10 |
| Molybdenum | 0-3 |
| Nickel | 0-5 |
| Iron | 0-10 |
| Manganese | 0-3 |
| Silicon | 0-5 |
| Vanadium | 0-5 |
| Carbon | 0-4 |
| Boron | 0-5 |
| Cobalt | Balance |

The powder cobalt-based alloy, for example, can comprise 27-31 wt. % chromium, 2-5 wt. % tungsten, 1-3 wt. % nickel, 0.1-1 wt. % manganese, 0.5-3 wt. %-iron, 0.5-2 wt. % carbon, 0-2 wt. % silicon, 0-2 wt. % boron and the balance cobalt. In some embodiments, the cobalt-based powder alloy comprises one or more melting point reduction additives in an amount sufficient to permit sintering of the alloy powder in a temperature range of 1140° C. to 1210° C. Melting point reduction additive can be one or more elemental components of the powder alloy. In some embodiments, elemental melting point reduction additives include silicon and/or boron. The cobalt-based alloy, for example, may contain silicon and/or boron in individual amounts of 0.1-2 wt. %. Cobalt-based alloy powders are commercially available under the STELLITE® trade designation.

In further aspect, the powder composition may comprise any metal, alloy and/or ceramic consistent with the technical principles described herein. In some embodiments, for example, the powder composition formed into the green article can comprise nickel superalloys, aluminum, iron, various steels including tool steels and/or stainless steel, and titanium. Particle size of metal, alloy and/or ceramic powders can generally range from 1-100 μm. In some embodiments, the metal, alloy and/or ceramic particles have an average size selected from Table III herein.

In some embodiments, the powder composition comprises nickel-based alloy having compositional parameters selected from Table VI.

TABLE VI
Nickel-based alloys

| Element | Amount (wt. %) |
|---|---|
| Chromium | 0-30 |
| Molybdenum | 0-28 |
| Tungsten | 0-15 |
| Niobium | 0-6 |
| Tantalum | 0-6 |
| Titanium | 0-6 |
| Iron | 0-30 |
| Cobalt | 0-15 |
| Copper | 0-50 |
| Carbon | 0-2 |
| Manganese | 0-2 |
| Silicon | 0-10 |
| Phosphorus | 0-10 |
| Sulfur | 0-0.1 |
| Aluminum | 0-1 |
| Boron | 0-5 |
| Nickel | Balance |

In some embodiments, for example, nickel-based alloy comprises 18-23 wt. % chromium, 5-11 wt. % molybdenum, 2-5 wt. % total of niobium and tantalum, 0-5 wt. % iron, 0.1-5 wt. % boron and the balance nickel. Alternatively, nickel-based alloy comprises 12-20 wt. % chromium, 5-11 wt. % iron, 0.5-2 wt. % manganese, 0-2 wt. % silicon, 0-1 wt. % copper, 0-2 wt. % carbon, 0.1-5 wt. % boron and the balance nickel. Further, nickel-based alloy can comprise 3-27 wt. % chromium, 0-10 wt. % silicon, 0-10 wt. % phosphorus, 0-10 wt, % iron, 0-2 wt. % carbon, 0-5 wt. % boron and the balance nickel.

The powder composition may also comprise iron-based alloy. In some embodiments, iron-based alloy comprises 0.2-6 wt. % carbon, 0-30 wt. % chromium, 0-37 wt. % manganese, 0-16 wt % molybdenum, other alloying elements and the balance iron. In some embodiments, powder iron-based alloy has a composition according to Table VII.

TABLE VII
Iron-based alloys

| Fe-Based Alloy | Compositional Parameters (wt. %) |
|---|---|
| 1 | Fe-(2-6)%C |
| 2 | Fe-(2-6)%C-(0-5)%Cr-(29-37)%Mn |
| 3 | Fe-(2-6)%C-(0.1-5)%Cr |
| 4 | Fe-(2-6)%C-(0-37)%Mn-(8-16)%Mo |

A body of the article is printed with the powder composition via one or more additive manufacturing techniques. Additionally, at least one region of unprinted loose powder is selectively located in the body during the printing process. The at least one region is defined by a boundary printed from the powder composition. As sintering has yet to take place, as described herein, the printed article is in the green state or unfinished state. The powder composition employed in the printing process can have any composition and/or properties described hereinabove. In some embodiments, the powder composition of the printed body, printed boundary, and unprinted loose powder region(s) are the same. In alternative embodiments, the unprinted loose powder is of different composition relative to the printed body and/or printed boundary.

Any additive manufacturing technique operable to accomplish the foregoing printing steps can be employed. In some embodiments, additive manufacturing techniques employing a powder bed are used to construct green articles formed of the powder composition. For example, binder jetting can provide a green article comprising the printed body, printed boundary, and unprinted loose powder. In the binder jetting process, an electronic file detailing the design parameters of the green part is provided. The binder jetting apparatus spreads a layer of the powder composition in a build box. A printhead moves over the powder layer depositing liquid binder according to design parameters for that layer. The layer is dried, and the build box is lowered. A new layer of the powder composition is spread, and the process is repeated until the green article is completed. In some embodiments, other 3D printing apparatus can be used to construct the green article from the sintered cemented carbide powder or alloy powder in conjunction with organic binder.

Any organic binder not inconsistent with the objectives of the present invention can be employed in formation of the green article by one or more additive manufacturing techniques. In some embodiments, organic binder comprises one or more polymeric materials, such as polyvinylpyrrolidone (PVP), polyethylene glycol (PEG) or mixtures thereof. Organic binder, in some embodiments, is curable which can enhance strength of the green article. In some embodiments, filament deposition is an additive manufacturing technique to form the green article.

As set forth herein, the at least one region of unprinted loose powder defined by the printed boundary is selectively located in the body during the printing process. The region(s) of loose powder can be selectively located at one or more functional areas of the sintered article. Functional areas, for example, can experience higher mechanical stresses, higher wear, and/or higher thermal cycling relative to an adjacent area of the sintered article.

The printed body, printed boundary, and the unprinted loose powder region are simultaneously sintered to provide the sintered article, wherein the region of sintered unprinted loose powder has a density higher than sintered porous boundary and sintered body. The higher density of the sintered loose powder region can impart enhanced mechanical properties, including, but not limited to, wear resistance fracture resistance, fracture toughness, and/or resistance to thermal cycling or fatigue. In some embodiments, the region of sintered unprinted loose power is at least 98 percent theoretical density. For example, the sintered unprinted loose power region can be 98-100 percent theoretical density or 99-100 percent theoretical density. In contrast, the sintered printed body and/or sintered printed boundary can be 90 to 98 percent theoretical density, in some embodiments. The sintered printed body and/or sintered printed shell can be porous while the sintered unprinted loose powder region can be substantially fully dense or fully dense, in some embodiments. The sintered printed body and/or sintered printed shell, for example, can exhibit 3-10 percent porosity.

In some embodiments, the printed body, printed boundary, and the unprinted loose powder region are not simultaneously sintered to provide the sintered article. For example, sintering of the printed body, printed boundary, and/or unprinted loose powder region can occur at differing times to produce the resultant sintered article having the architecture described herein. Differing sintering times can occur if differing powders are employed between the various structural components of the printed body, printed boundary, and/or unprinted loose powder regions.

Regions of sintered unprinted loose powder can have any desired dimensions. Dimensional aspects of regions of sintered unprinted loose powder can be selected according to several considerations including intended function of the regions, specific location of the regions in the sintered article, compositional identity of the sintered unprinted loose powder, and overall dimensions of the sintered article.

Moreover, in some embodiments, the sintered printed boundary can have any desired thickness. In some embodiments, the printed boundary has a thickness of 0.5 mm to 5 mm. In some embodiments, the sintered printed boundary can be partially or completely removed to expose at least a portion of the underlying sintered unprinted loose powder region. Depending on article design, the sintered article body can serve as the sintered boundary in some embodiments. In such embodiments, the sintered body and sintered boundary are functionally the same.

Sintered articles made according to methods described herein can be tools, industrial articles or components, or mechanical system articles or component. In some embodiments, the sintered articles are cutting tools, including cutting inserts and round tools. The region(s) of sintered unprinted loose powder can be selectively placed at one or more functional regions of the tool, such as the cutting edge, chip breakers, flutes, and/or coolant passages.

These and other embodiments are further illustrated in the following non-limiting examples.

### Example 1—Sintered Article Comprising Sintered Unprinted Loose Powder Region

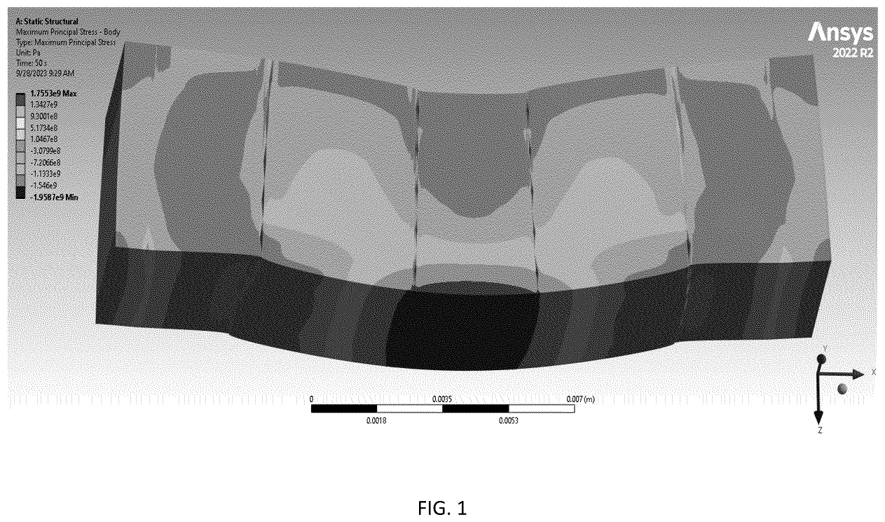

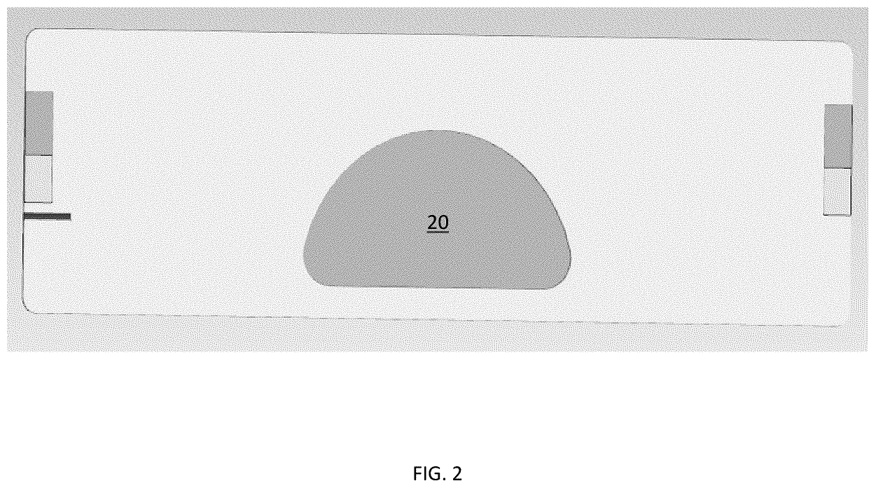

Test articles, consisting of transverse rupture test bars, with a selectively localized unprinted sintered loose powder region were designed by performing a finite element analysis (FEA) to determine the stress state of a transverse rupture bar while being tested according to ASTM B406. FIG. 1 illustrates the results of this FEA, illustrating the high stress region at the bottom-center of the test bar. A small, localized region of sintered unprinted loose powder was then designed into the model corresponding to this region of maximum stress, as shown in FIG. 2.1 mm of sintered printed boundary was then added to the transverse rupture bar to encapsulate the loose powder region and to allow for finish machining to necessary dimensions according to ASTM standard.

The model shown in FIG. 2 was printed out of WC-10Co powder using a GE-H2 binder jet printer and a water-based Rapidwick binder available commercially from GE. Individual layer thickness was 50 μm and the bars were printed at 160% saturation. Green density for these components were 40-45% theoretical density.

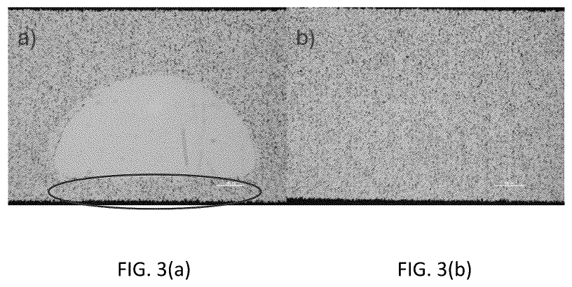

The bars were then cured in a curing oven at 200° C. in a N₂ atmosphere, with a gas flow rate of 38 L/min, for 4 hours. After curing, bars were depowdered, to remove the unbound powder surrounding the part, using vacuum. The unprinted loose powder encapsulated in the region/compartment was not removed and left to remain internally in the printed part. The bars were then placed on a graphite sintering tray, coated with a graphite-based parting agent, for debinding and sintering in a sinter-HIP furnace. Debinding was performed via heating the bars to 538° C. in an H₂ atmosphere. Sintering was then performed at 1480° C. for 120 minutes, with an overpressure of 5.5 MPa being applied for the final 30 minutes of the cycle. A shrinkage of 20-30% was observed for the samples. The bars show differing levels of density between the region of sintered unprinted loose powder (98% theoretical density and above) and the remainder of the sintered printed area (90-98% theoretical density), shown in FIG. 3(a). The region of sintered unprinted loose powder exhibited A02B00C00 porosity or lower, compared to A02B08C00 or higher in the bulk/body printed area, adhering to the ASTM B276 standard. As set forth below, the boundary region circled in FIG. 3(a) is ground away to expose the region of sintered unprinted loose powder. FIG. 3(b) illustrates a transverse rupture bar without a region of sintered unprinted loose powder having A02B08C00 or higher.

The transverse rupture bar samples were then ground to the appropriate shape, dimension, and surface finish for transverse rupture testing in accordance with ASTM B406 standard. In doing so, the bottom of the transverse rupture bar was ground to expose the fully dense, sintered unprinted region. This was done to ensure this region of sintered unprinted loose powder is in the region of maximum stress as determined by the FEA shown in FIG. 1. Fully printed bars that do not contain an region of unprinted loose powder were also prepared using the same processing conditions described above to act as control samples for comparing the improved performance because of this invention. An example of their porosity levels in the region of maximum stress can be found in FIG. 3(b).

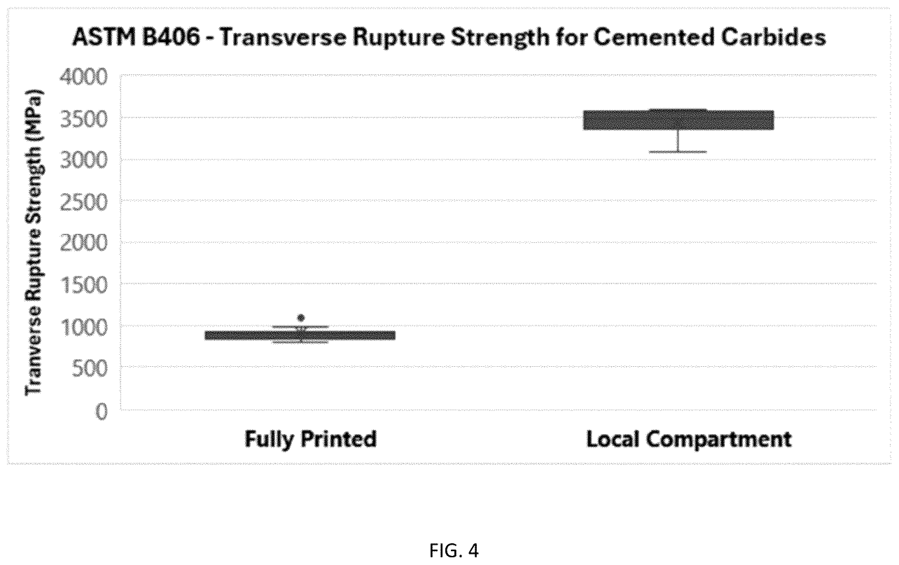

Transverse rupture testing, in accordance with ASTM B406, was performed on both sets of transverse rupture bars. Samples prepared with a region of sintered unprinted loose powder exhibited an average transverse rupture strength (TRS) of 3417 MPa, while the control samples without a region of sintered unprinted loose powder in the region of maximum stress had an average of 932 MPa TRS for the same processing conditions, as provided in FIG. 4.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A method of making a sintered article comprising:
printing a body from a powder composition via one or more additive manufacturing techniques;
selectively locating at least one region of unprinted loose powder in the body during the printing, the at least one region defined by a boundary printed from the powder composition; and
sintering the printed body, the printed boundary, and the unprinted loose powder region to provide the sintered article, wherein the sintered unprinted loose powder region has a density higher than the sintered printed boundary and/or sintered printed body.

2. The method of claim 1, wherein a plurality of regions are selectively located in the body.

3. The method of claim 1, wherein the sintered printed body and sintered printed boundary are porous.

4. The method of claim 1, wherein the region of sintered unprinted loose powder is greater than 98 percent theoretical density.

5. The method of claim 4, wherein the sintered printed body and/or sintered printed boundary are 90-98 percent theoretical density.

6. The method of claim 1, wherein the sintered printed boundary has a thickness of 0.5-5 mm.

7. The method of claim 1, wherein the at least one region is located at a functional area in the sintered article.

8. The method of claim 7, wherein the functional area experiences higher mechanical stress relative to an adjacent area of the sintered article.

9. The method of claim 7, wherein the functional area experiences higher wear relative to an adjacent area of the sintered article.

10. The method of claim 7, wherein the functional area experiences higher thermal cycling relative to an adjacent area of the sintered article.

11. The method of claim 1 further comprises removing at least a portion of the sintered printed boundary and/or sintered printed body.

12. The method of claim 11, wherein the region of sintered unprinted loose powder forms an exterior portion of the sintered article after removal of the portion of the sintered printed boundary and/or sintered printed body.

13. The method of claim 1, wherein the powder composition is selected from the group consisting of powder metal and powder alloy.

14. The method of claim 13, wherein the powder alloy comprises cobalt-based alloy, nickel-based alloy, iron based alloy or combinations thereof.

15. The method of claim 1, wherein the powder composition comprises sintered cemented carbide particles.

16. The method of claim 1, wherein the powder composition and the unprinted loose powder have the same composition.

17. The method of claim 1, wherein the powder composition and unprinted loose powder have different compositions.
